(19) United States
(12) Patent Application Publication
(10) Pub. No.: US 2014/0234807 A1
(43) Pub. Date: Aug. 21, 2014

(54) WEIGHT MANAGEMENT METHOD

(71) Applicant: Christopher Brian Lundin, Wilmington, DE (US)

(72) Inventor: Christopher Brian LUNDIN, Wilmington, DE (US)

(73) Assignee: Christopher Brian Lundin, Wilmington, DE (US)

(21) Appl. No.: 14/177,486

(22) Filed: Feb. 11, 2014

(30) Foreign Application Priority Data
Feb. 20, 2013 (ZA) 2013/01293

(51) Int. Cl. G09B 19/00

(52) U.S. Cl. CPC G09B 19/0092
USPC 434/127

(57) ABSTRACT

The invention is directed to a weight management method, designed to stabilise and optimise insulin levels.

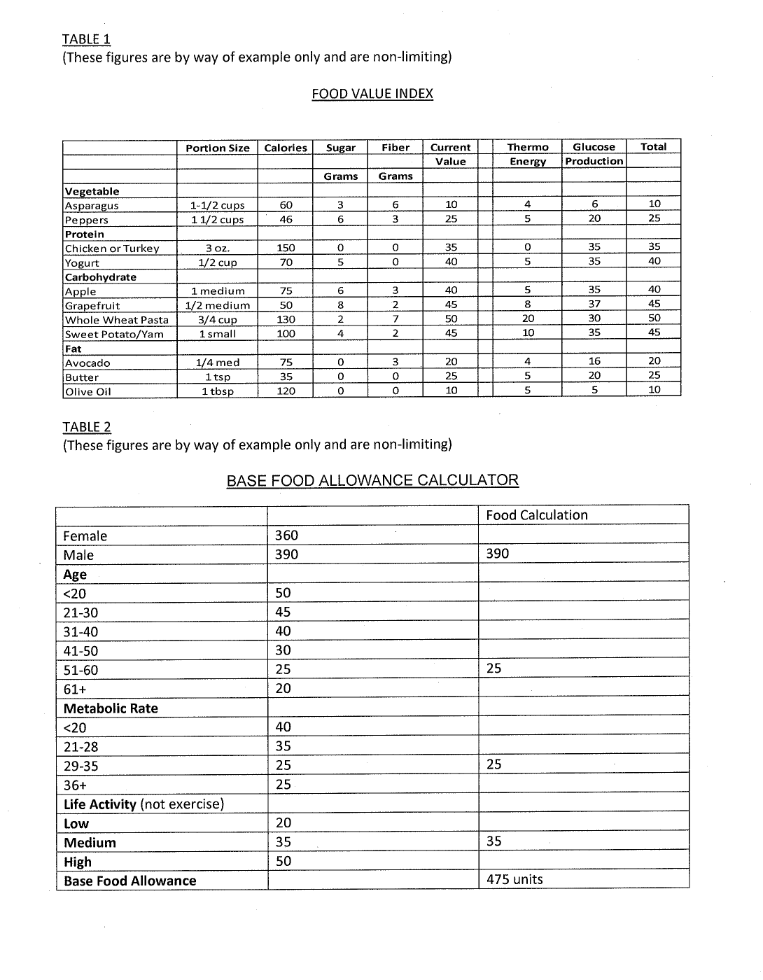

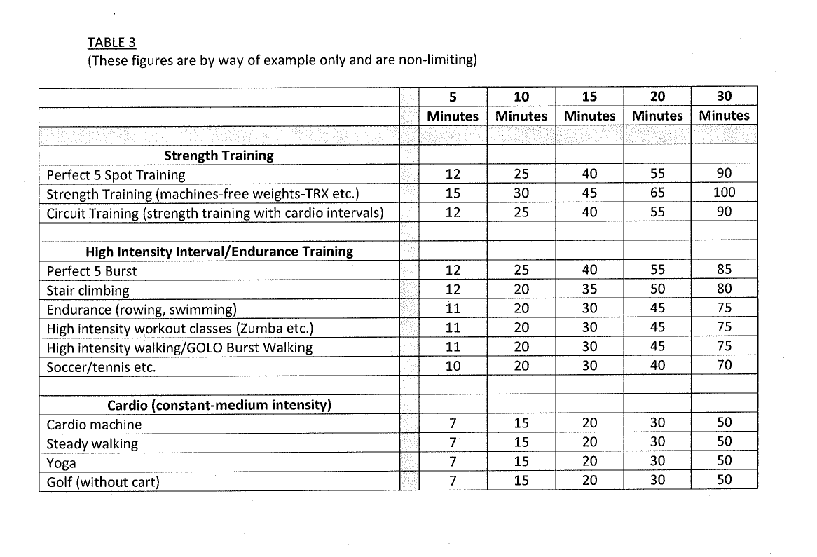

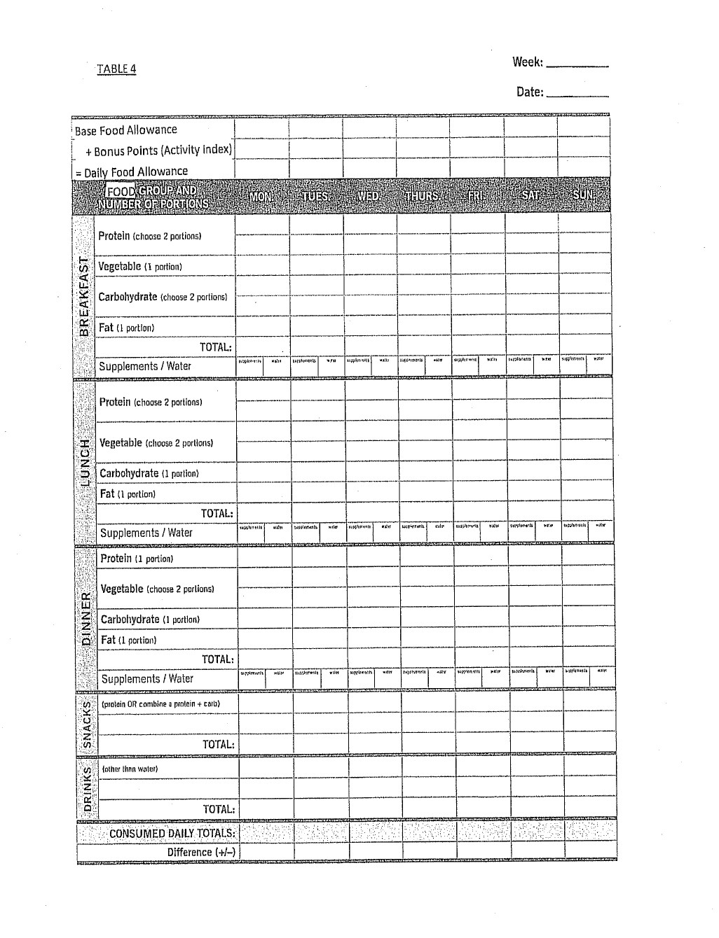

### BACKGROUND OF THE INVENTION

This invention relates to the management of an individual's weight.

A substantial industry exists worldwide in respect of weight management programs typically directed to achieving weight loss. An abundance of high caloric-value foods, particularly in developed countries, and an increase in sedentary occupations and activities, have led to an almost continuous increase in the average weight of consumers. In many countries a majority of the population is overweight and large numbers of people are obese. As a consequence the weight loss industry is substantial and it is estimated that, in the US alone, over sixty billion dollars a year is spent on diets and diet products.

Many techniques have been proposed to achieve weight loss. Without being exhaustive these techniques include the following:

Counting Calories

A calorie-controlled diet restricts calorie intake by a consumer on a daily basis. Many people are, however, not able to determine their actual calorie needs reliably and diet programs often fail to consider, properly, lifestyle activity (a measure of activity without taking exercise regimes into account) and exercise. Foods are categorised according to caloric values and no or little consideration is taken of food groupings, nutritional value, thermogenesis, muscle loss due to calorie restriction, BMR calculations, the effect of food on insulin levels in an individual and so on.

Point Systems

Some organisations promote the use of points, as opposed to calories, to simplify diet regimes for an individual. A point system is, in general, based on the calorie levels of foods and, from this point of view, is a modified calorie counting system. A dieter is able to “accumulate” points and this can promote binge eating which, in itself, is neither healthy nor effective.

Calorie counts are normally done in hundreds. A very low caloric intake is 600. This, in itself, is dangerous. A very high intake is of the order of 3000 which is excessive. In a typical weight loss program a calorie count is set at between 800 to 1200 calories.

To lose weight by counting calories one would either follow a fixed meal plan where the calories have been already worked out at, say, 800. With 100% compliance a dieter would consume 800 calories. Alternatively a dieter could follow established guidelines to determine his or her estimated resting base metabolic rate (BMR) before activity and use that as a base line to maintain weight. A reduction in intake creates a caloric deficit.

It is submitted that each approach is flawed and not accurate. No account is taken of a person's muscle mass versus fat mass and of the effect of activity which can result in a calorie intake which is not sufficient to sustain health and avoid muscle loss. Most calorie-restricted diets also restrict or minimise certain food groups like carbohydrates or fats, or allow people to accumulate calories for indulging, an occurrence which raises glucose and insulin levels, thereby slowing or shutting down the metabolism process. For example, a serving of 3 ounces of boneless/skinless chicken would be approximately 150 calories and 2 cups of popcorn would be approximately the same calories but would create significantly more glucose and fat storage than the chicken.

In a typical points system used by a leading weight loss company a daily range of approximately 20 to 30 points is established. For example a person would be given a daily number of points of 20 with a weekly bonus of 49 points (7 per day). It is believed that this approach is flawed for a number of reasons:
(1) the point systems allows “hoarding” of points. When the accumulated points are used this is often part of a “binge” process and, as indicated, this creates low and high blood sugar levels which affect the metabolic rate and lead to hunger and food cravings;
(2) a target range of, say, 20 to 30 points per day is small. One point variation in the range is equivalent to an approximate 5% variation in the range. No account is taken of the glucose and energy contents of the foods. For example a bagel, granola bar and 3 oz. of boneless/skinless chicken are each equated to 3 points. However the bagel and granola bar respectively create significantly more glucose and fat storage than the chicken;
(3) a point system is not necessarily linked to healthy eating. 6 oz. of skinless chicken and one cup of rice equate to 10 points whereas a meal replacement bar or shake is 3 points. A hamburger is only 6 points;
(4) vegetables are rated at zero points and most fruits are also rated at zero points. This induces a participant in a weight loss program to avoid eating proteins, carbohydrates and fats, and promotes the consumption of meals which do not include protein. These choices manifest themselves in a slow-down of the metabolic rate, fat storage and consumption of muscle for energy; and
(5) a point system generally slows down the metabolic rate due to excessive muscle loss during the weight loss process. It does not necessarily promote an enduring lifestyle change in eating habits. A participant who reverts to a regular diet inevitably gains weight rapidly, due to the reduced muscle mass and to the body being accustomed to survive on fewer calories.

Glycemic Index

The glycemic index (GI) was developed to determine which foods are best for diabetics. This approach transformed into the marketing of weight loss diets for the public in general. The GI is designed to measure the effect of carbohydrates on blood sugar levels. Without being exhaustive, criticisms which have been leveled at the glycemic index approach include the following:
(a) no account is taken of fat or fiber content in foods or a fruit food which is consumed with a second food and which could affect the GI of the second food;
(b) the GI of a particular food is measured relative to white bread and no account is taken of exercise;
(c) the GI of a food can vary depending on how the food is cooked or processed; and
(d) depending on blood glucose levels, health factors, insulin-resistance, meals consumed, time of day and the like, the glycemic response to particular foods can be different from one person to another.

Glycemic Load

The glycemic load is, perhaps, a more accurate indicator of carbohydrate conversion and its effect on blood sugar and insulin levels. Glycemic load considerations are generally more acceptable for use by diabetics and are not particularly useful for individuals who are not diabetic but who are attempting to lose weight. Also, the tracking of a glycemic load index intake can be difficult for the magnitude of a glycemic load is based on weight measured in grams.

Insulin Index

The insulin index is a measure used to quantify the insulin response of an individual to various foods. It is based upon blood insulin levels and not on glucose levels. The index is relative to white bread. However, only a limited amount of research has been done in respect of the insulin index. Taken at face value the use of the insulin index can adversely categorize certain foods such as eggs and meat despite the fact that these types of foods are needed for proper body function in that they produce insulin and cause the body to release glucagon, a composition which keeps blood sugar stable.

Thermogenesis-Based Diet

This type of diet is primarily focused on high protein foods and limits the intake of fats and carbohydrates. Effectively a person who eats healthy meals from all four food groups is penalized.

The present invention is concerned with a weight management method which aims to address certain shortcomings which are associated with the aforementioned techniques and which helps to promote fat loss in a safe manner with minimal or no muscle loss, while assisting a consumer to achieve a permanent weight loss.

### SUMMARY OF THE INVENTION

The weight management method of the invention is designed to stabilise and optimise insulin levels which are important in reducing the amount of glucose which is converted to fat. The management of insulin levels can address, at least to some extent, diabetes risk factors. Many overweight people have a condition called “insulin resistance” (IR) which causes an over-production of under-performing insulin which makes it easier to gain weight and harder to lose weight. IR is a primary cause of a slow metabolism.

The method of the invention includes the following steps:
(1) establishing a food index which includes a listing of a plurality of foods which are divided into four groups, namely vegetables, proteins, carbohydrates (which include starches and fruit), and fat and, for each food, defining a portion and a food value thereof, in units, the food value being based at least on the following parameters:
diet induced thermogenesis, and
glucose and insulin activation,
(2) determining a consumer's base food allowance, in terms of said units, based at least on one or more of the following parameters of the consumer:
(a) gender;
(b) age;
(c) muscle mass to fat ratio;
(d) height;
(d) waist circumference; and
(f) life activity.
(3) determining for the consumer, in said units, an activity index which is dependent on the nature of physical exercise engaged in by the consumer;
(4) determining, for the consumer, a daily food allowance, in said units, as the sum of the base food allowance and the activity index, and
(5) allowing the consumer to choose, from said food index, portions of foods for consumption, wherein the sum of the units of the food values of the chosen portions of foods is in a predetermined relationship relative to the daily food allowance, subject to the following: at least one food portion is selected from each food group for each meal, and three meals are consumed each day.

In step (1), in establishing the food index, all relevant foods are assigned an insulin value which is referred to as the “food value”. The food value is based on various parameters which include the following:
“diet-induced thermogenesis” which is the energy which is required to digest consumed food; and
“glucose and insulin activation” which is the amount of glucose that is produced from consumed food and the corresponding insulin production to manage the glucose.

The base food allowance, determined in step (2), is linked to the quantity of food a consumer can consume each day, before exercise, to lose between one and two pounds of fat weight per week.

The activity index in step (3) is dependent on the nature of physical exercise activities undertaken by a consumer on a time basis. For example, the activity index is based on or linked to activities such as walking for thirty minutes, swimming for fifteen minutes, and so on.

The daily food allowance (step (4) (in said units), which is the sum of the base food allowance and the activity index, represents the food that a consumer should consume each day in order to lose between one two pounds of fat per week.

In step (5) a consumer is guided to choose foods, from all four food groups, from the listing in the food index, on a portion basis. In practice the consumer should consume not less than 90%, and not more than 110%, of the daily food allowance. If less than 90% is consumed the consumer has the risk of eating too few calories—this can lead to muscle loss and fatigue and, ultimately, to a slower metabolism. If food consumption (in units) exceeds 110% of the daily food allowance then the loss of fat is reduced and zero weight loss may result.

It is evident from the aforegoing that, at least in one aspect, the method of the invention is not focused on calorie intake but rather on the effect of food on the metabolic rate, the energy needed to digest and burn consumed food, and the projected effect of food consumption on glucose production.

The method of the invention may be implemented directly e.g. by a consumer who follows a chart, tables or the like. In a preferred implementation method, however, use is made of a computer link, e.g. the internet, which allows a plurality of consumers to interact individually with a program located at a suitable server.

Each consumer, once authorised, is guided to register an online profile. The consumer is prompted to enter information, in accordance with the predetermined parameters, and, in response thereto, a calculation is done to determine the consumer's base food allowance (as per the aforementioned step (2).

The consumer is subsequently prompted to enter information on the consumer's activities, on a daily or other regular basis. Each activity which is logged influences the activity index referred to in the aforementioned step (3). Alternatively or additionally the program, in response to data input by the consumer, may generate an activity program, suited for the consumer, which, inherently, will lead to the allocation of an associated activity index to the consumer.

In response to the determined base food allowance and activity index, for the consumer in question, the program then outputs the daily food allowance for the consumer which is the sum of the base food allowance and the activity index.

In any weight loss program motivation is a key ingredient to success. Motivational factors are introduced by the program and presented to the user in various forms. For example a formula may be implemented to enable a person to determine an insulin resistance score. The rationale behind this is that the person can then be presented with data which indicates his or her level of insulin resistance and which attaches a qualitative factor to it e.g. potentially harmful, excessive, dangerous, etc. This then is linked to a message which brings home to the consumer the importance of managing food intake using the method of the invention.

Additionally a results-tracking program is started and updated regularly. This allows the user to have a personal assessment, commencing at starting point, which includes data such as the dieter's starting weight, starting waist measurement, base food allowance and activity index. Examples may be given of the daily food allowance (i.e. the sum of the base food allowance and the activity index).

Other information of interest, primarily related to motivational aspects, may be included and displayed at appropriate intervals to the consumer. For example data on the consumer's goal weight, metabolic age estimate, stress and emotional eating score, and processed food score may be included.

A primary reason behind the use of the personal assessment program lies in the fact that it provides a ready means for implementation of the method of the invention. This however is done in a way which motivates the consumer to achieve targets and to become aware of the effect that the intakes of different types of food might have on the consumer's body. Ultimately the use of the personal assessment program helps the method of the invention to be implemented in a reasonable and not in a stressful manner, and leads the consumer to a healthy eating style which can readily be maintained.

A primary objective of the method of the invention is to enable a consumer to eat balanced meals of healthy foods without suffering from hunger pangs, food cravings, and isolation from family and friends, particularly at meal times. In the last-mentioned respect it is recognised that social considerations can weigh heavily on the effectiveness of a weight management regime and, taken in isolation, a weight management program which a consumer regards as anti-social can cause the consumer to abandon the program in its entirety.

Essentially the method of the invention is based on a formula which enables a consumer to balance energy in against energy expended with a deficit to promote fat weight loss. This allows the consumer to achieve weight loss with minimal or no muscle loss on a consistent and sustainable basis. The food groupings and portion control allow a consumer to maintain a high energy level. Risks which are associated with diabetes and heart disease and which are linked to intake of certain food types are reduced in the method of the invention.

### Brief Description of the Tables

The invention is further described by way of example with reference to the accompanying representations wherein:
Table 1, which is taken from a food index which is established in the course of implementing the method of the invention, indicates how certain food types have defined portions assigned to them, and the number of food value units associated with each portion,
Table 2 is a chart illustrating how a base food allowance is determined in units in accordance with various defined parameters,
Table 3 reflects an activity index, and
Table 4 illustrates a food log which allows a record to be kept of the actual daily food consumption of a consumer and comparison to be made between the actual daily food consumption and the daily food allowance of the consumer.

### DESCRIPTION OF PREFERRED EMBODIMENT

The method of the invention depends on the creation and use of a unit which is a common measure used to link, in respect of a consumer, food values of defined portions of each of a variety of foods to a base food allowance for the consumer and to an activity index of the consumer.

As an initial step a food index is established. In this index each of a variety of foods is assigned an insulin value which is referred to as the “food value”. Table 1 is an extract from a food index and reflects food values for food groups i.e. vegetable, protein, carbohydrate and fat. Each food group includes a number of different foods e.g. for vegetable the entries are asparagus and peppers while, for fat, the entries are avocado, butter and olive oil. It is to be understood that these food types are exemplary only. Additionally a portion size is reflected adjacent each food type e.g. one portion of asparagus is 1½ cups; one portion of chicken comprises 3 oz. and one portion of sweet potato is a small potato. The food value of each food type, per defined portion, is given in an adjacent column in the units which are used in the method of the invention. e.g. a portion of asparagus has a food value of 10 units; one portion of chicken has a food value of 35 units and one portion of sweet potato has a food value of 45 units.

The food values are based on two criteria namely (a) thermogenesis, which is the energy required to digest a particular food which has been consumed; and (b) a measure of the extent to which the food activates or promotes the production of glucose and insulin;

The method of the invention uses a base of 500 units as a starting point. Those 500 units are associated with an average person with moderate life and exercise activity. 500 units provides sufficient variance between food groups and food types to allow a person to determine energy intake and energy output. Food groups and the individual foods are given a number of units based on diet-induced thermogenesis and glucose effect and that number of units is reflected in corresponding columns to the right in the table. Typically a person implementing the method of the invention would have a daily food allowance of from 420 to 650 units i.e. straddling the base of 500.

The method of the invention focuses on whole foods and on feeding the body nutritious foods which are low in preservatives and additives and which are not necessarily low in fat or calories. The intention is to control satiety and to sustain energy while energising the metabolism. The food intake program of the present invention is not intentionally based on a restricted caloric diet.

In broad terms the unit used in the method of the invention is equivalent to a calorie intake of from 2.7 to 3. The base starting point of 500 units thus equates to a calorie value of from 1350 to 1500. This is a healthy caloric intake which, nonetheless, enables a user to lose fat while maintaining muscle.

Referring for example to Table 1 one portion of asparagus has a higher calorie content than 1 portion of peppers. However the units associated with these vegetables are 10 and 25 respectively. This indicates that, in the method of the invention, asparagus is preferred over peppers to optimise insulin.

The method of the invention is also designed to ensure that a dieter has the correct intake of protein, fat, carbohydrates, starches and fruit and vegetables to optimise insulin and to maximise energy while causing the body to burn fat without any meaningful muscle loss. The maximum deviation from the base allowance of 500 units, for an average consumer, minimises the likelihood that muscle will be converted to energy—a situation which is often encountered in a calorie-restricted diet.

The thermogenesis calculation is determined by the energy consumed. The higher the thermogenesis effect is for a given food, the lower is the number of units which that food contributes to the overall food value, when linked to the glucose production value. The glucose score is based on the predicted glucose production for the different food groups.

The food index, referred to in connection with Table 1, constitutes a fundamental aspect of the method of the invention and is non-variable in that it is not consumer-specific and applies equally to all consumers.

Table 2 shows a chart which, in respect of a consumer, allows that consumer to perform a metabolic calculation to determine his or her base food allowance in terms of units which are identical to the units used to represent food values, as per Table 1.

The base food allowance is linked to one or more of the following parameters, namely: the consumer's gender, age, waist circumference, muscle mass to fat ratio, height and life activity, as set out in a first column of Table 2. Other parameters, such as the consumer's body mass index and height to waist ratio can also be used to perform the metabolic calculation. A second column of Table 2 contains, in respect of each of the aforementioned parameters, the quantity of units in the corresponding base food allowance.

A third column in Table 2 allows a consumer to enter the number of units which apply to that consumer. For example, a male consumer in the age group of 51 to 60, with a metabolic score of 25, and with a medium life activity index, has a base food allowance of 475 units.

Table 3 allows a consumer to determine an activity index in units which are common to the units which apply to Table 1 and Table 2. The activity index is determined in accordance with exercise type (this is divided into strength training, high intensity interval training/endurance training and cardio (constant-medium intensity)and the duration of the exercise. Thus, with reference to Table 3, if a consumer does strength training for 20 minutes together with 15 minutes of steady walking the activity index for that consumer per day is 85 units.

In use, an online program enables a consumer to create an online profile which includes all relevant personal information, and his particular weight loss goal. The program uses this information to calculate the consumer's daily food allowance.

If the consumer participates in any activities, he is able to log these activities on his online profile and the program updates the consumer's daily food allowance according to the particular activity and the duration thereof.

As an alternative, the program can provide the consumer with a daily/weekly activity goal which must be achieved in order to lose weight.

The program provides the consumer with a reasonable period within which to achieve his weight loss goal, and keeps track of the consumer's daily food intake in units, as well as the progress made in terms of weight loss, provided the consumer diligently logs his meals and updates physical changes on his profile regularly.

In the method of the invention the concept of a daily food allowance for a consumer is established as the sum of the consumer's base food allowance and activity index. Table 4 provides information which allows a consumer to record selected food from defined food groups in Table 1 within the prescript of the consumer's daily food allowance.

There are four food groups namely protein, vegetable, carbohydrate and fat. The consumer is allowed two protein portions and two carbohydrate portions, one vegetable portion and one fat portion for breakfast. For lunch the consumer should have two protein portions, two vegetable portions, one carbohydrate portion and one fat portion. For dinner the consumer should have one portion of protein, two vegetable portions, one carbohydrate portion and one fat portion. Provision may also be made for the consumption of snacks, drinks or supplements. This aspect is of a minor nature though.

Reference is made to Table 1 which, as described, constitutes part of a food index which reflects food types, and for each food type, a portion size and a food value in units. Table 1, by way of example only, includes a limited number of foods. In practice an extensive food list is provided for the consumer's use.

Table 4 covers three meals a day namely breakfast, lunch and dinner for seven days a week i.e. from Monday to Sunday. The daily food allowance is applicable to each day. In Table 4 each day heads a column which bridges breakfast, lunch and dinner and, at the end of each day, the consumer can calculate, in the defined units, the quantity of food consumed in the day. That quantity should be compared to the daily food allowance. As stated the actual quantity of food, in units, consumed each day should be not less than 90% of the daily food allowance and not greater than 110% of the daily food allowance.

The food groups used in the method of the invention are vegetables, protein, carbohydrates (which includes starches and fruit) and fat. The method requires the inclusion of at least one portion of each food group with each meal and promotes the consumption of three meals a day using all four food groups, with snacks, as may be appropriate. This scheme assists with the stabilisation of insulin levels in the consumer.

As an example, a single bagel and a glass of orange juice equate to 300 food value units, and represent approximately one and a half times the glucose and insulin loads which would be created by the consumption of two eggs, a slice of toast, a cup of fruit, a cup of vegetables and one teaspoon of real butter (±200 food value units).

A consumer who ate the bagel and juice would have an insulin spike which results in an increase in fat storage but there would be no protein or fat consumption. Energy levels would rapidly decline within about two hours resulting in a reduction in the metabolism rate and this would create a need for food and sugar. The alternative food consumption proposed would allow the consumer to produce less glucose and insulin. Excess glucose would not be stored as fat. In response to the ingestion of the alternative foods (eggs, toast, fruit etc.) the body would accelerate the metabolic rate, and would seek energy reserves from stored food. Satiety and high energy levels would be maintained for three to four hours or until legitimate hunger pangs again arose.

The method of the invention is linked to the creation of healthy meals using a meal planner which facilitates the making of selections from the complete food index (Table 1 only shows a small part thereof).

Through the application of the method of the invention a consumer is capable of achieving a consistent fat loss of up to two pounds a week until the desired weight is lost. As a consumer's metabolic rate adjusts due to an increased consumption of healthy food the consumer can increase his intake of food value units. In this way the method of the invention helps a consumer to establish a life-sustainable diet and eating regime.

The base food allowance can change depending on variations in the parameters. Thus an increase in the life activity level of a consumer results in an automatic increase in the consumer's base food allowance. Similarly, an increase in age causes the base food allowance to reduce, and so on.

Test Results

33 subjects participated in a weight management program using the aforementioned principles. The effects of the program on each subject were tracked for a period of 29 weeks.

On average the 33 subjects were 74% compliant in respect of food intake and 75% compliant in respect of exercise i.e. activity index. In other words the subjects consumed, in food terms, approximately 600 units per day (this is about 1700 calories per day) before exercise and before taking into account the “bonus” units associated with each person's activity index. Each person, on average, exercised for 90 minutes per week.

Despite a calorie intake which is meaningfully larger than the intake allowed by a calorie-restrictive diet, the subjects reported an average weight loss of 32 lbs. over the 29 week test period i.e. a weight loss of slightly more than 1 lb. per week. The lowest weight loss over the 29 week period of a subject was 11 lbs. and the highest weight loss of a subject was 49 lbs.

There was a significant reduction (6 inches) in average waist measurement and the average reduction in body mass index was 15%.

The subjects ate whole foods, real fats and sugar and minimised the intake of low fat and sugar substitutes. Despite this the subjects reduced their triglyceride index by 28% and blood glucose levels by 9% with all risk factor indicators lowering significantly.

20 of the 33 participants had metabolic syndrome i.e. they were at risk of diabetes and heart disease, at the start of the trial. At the end of the 29 week period only 2 of these participants had metabolic syndrome and, as a group, risk factors in total were reduced by 64%.

75% of the subjects who were on cholesterol-lowering medications were able to eliminate such medications. 67% eliminated their diabetes medications and 50% eliminated blood pressure medications.

1. A weight management method, designed to stabilise and optimise insulin levels, which includes the following steps:
(a) establishing a food index which includes a listing of a plurality of foods which are divided into four groups, namely vegetables, proteins, carbohydrates (which include starches and fruit), and fat and, for each food, defining a portion and a food value thereof, in units, the food value being based at least on the following parameters: diet induced thermogenesis, and glucose and insulin activation,
b) determining a consumer's base food allowance, in terms of said units, based at least on one or more of the following parameters of the consumer: gender; age; muscle mass to fat ratio; height; waist circumference; and life activity.
c) determining for the consumer, in said units, an activity index which is dependent on the nature of physical exercise engaged in by the consumer;
d) determining, for the consumer, a daily food allowance, in said units, as the sum of the base food allowance and the activity index, and
e) allowing the consumer to choose, from said food index, portions of foods for consumption, wherein the sum of the units of the food values of the chosen portions of foods is in a predetermined relationship relative to the daily food allowance, subject to the following: at least one food portion is selected from each food group for each meal, and three meals are consumed each day.

2. A method according to claim 1 wherein the food value is based at least on the following parameters: diet-induced thermogenesis; glucose and insulin activation.

3. A method according to claim 1 wherein the base food allowance, determined in step b), is linked to the quantity of food a consumer can consume each day, before exercise, to lose between one and two pounds of fat weight per week.

4. A method according to claim 1 wherein the activity index in step (c) is dependent on the nature of physical exercise activities undertaken by a consumer on a time basis.

5. A method according to claim 1 wherein the daily food allowance (step (d) (in said units), which is the sum of the base food allowance and the activity index, represents the food that a consumer should consume each day in order to lose between one and two pounds of fat per week.

6. A method according to claim 1 wherein the consumer is guided to must consume between 90% and 110%, of the daily food allowance.

7. A method according to claim 1, which is implemented directly by a consumer who follows a chart or tables.

8. A method according to claim 1, which is implemented by means of a computer link, such as the internet, which allows at least one consumer to interact individually with a program, located at a suitable server.

9. A method according to claim 1, which is computer implemented and wherein a consumer is guided to register an online profile and to enter information, in accordance with the predetermined parameters, and, in response thereto, a calculation is done to determine the consumer's base food allowance as per step (b).

10. A method according to claim 9 wherein the information includes information on the consumer's activities, on a daily or other regular basis.

11. A method according to claim 10 wherein each activity which is logged influences the activity index referred to in step (c).

12. A method according to claim 9 wherein, in response to data input by the consumer, an activity program is generated which is suited for the consumer, and which, inherently, will lead to the allocation of an associated activity index to the consumer.

13. A method according to claim 9 wherein, in response at least to the determined base food allowance for the consumer, in question, a determination is made of the daily food allowance for the consumer which is the sum of the base food allowance and the activity index.

14. A method according to claim 9 wherein motivation factors, selected at least from the following; the consumer's goal weight, metabolic age estimate, stress, emotional eating score and process food score are presented to the consumer.

15. A method according to claim 1 wherein steps a) to e) are based on a formula, which enables a consumer to balance energy in against energy, expended with a deficit to promote fat weight loss.
